(19) United States
(12) Patent Application Publication
(10) Pub. No.: US 2008/0201003 A1
(43) Pub. Date: Aug. 21, 2008

(54) Method and system for reticle scheduling

(75) Inventors: Ashish Maskara, Singapore (SG); Nurulhuda Binte Jumahri, Singapore (SG)

Correspondence Address: STEPHEN B. ACKERMAN, 28 DAVIS AVENUE, POUGHKEEPSIE, NY, 12603, US

(73) Assignee: TECH Semiconductor Singapore Pte Ltd

(21) Appl. No.: 11/708,391

(22) Filed: Feb. 20, 2007

(51) Int. Cl. G06F 19/00

(52) U.S. Cl. 700/101; 700/121

(57) ABSTRACT

Methods and systems for reticle scheduling in semiconductor manufacturing providing a trade-off between complying with level priority and maximizing scanner utilization for critical scanners as a whole is disclosed. The extent of trade-off is specified by user, depending on scanner excess capacity. The method invented comprises, first, the steps of an initialization block performing splitting planning horizon into time buckets, initialization of system variables, and reading data on work-in-process, scanner/reticle status and reticle locations. The following block determines which buckets to run optimization for. The next method block is building a network for optimization based on inputs from inline real-time dispatching (RTD) followed by running optimization of the network. The last method block updates WIP and reticle information based on optimization results and feeds the results into a wafer lot assignment system.

### BACKGROUND OF THE INVENTION

(1) Field of the Invention

This invention relates to a method and a system for reticle scheduling in semiconductor manufacturing. In particular, a method that takes into consideration level priority and photolithographic scanner utilization for all photolithographic scanners as a whole.

(2) Description of the Prior Art

In semiconductor manufacturing, cycle-time is a most critical factor. It is well known that the escalating costs of photolithography, comprising the most expensive equipment of a semiconductor manufacturing line, are a dominant factor of total manufacturing costs. Being one of the processes that is repeated the most during fabrication, any reduction in photolithography cycle-time will reduce overall manufacturing cycle time significantly. Idle photolithographic scanners, waiting for a reticle required to continue a photolithographic process are generating most expensive cycle time.

The commonly used method for reticle dispatch for photolithographic scanners is to allocate a reticle to the highest priority device/level/scanner. Such known method does not take into consideration the impact to the other scanners which in turn causes the highest priority scanner to have a very good schedule whereas the lower priority scanners can end up with a bad utilization hence resulting in poor overall quality of reticle schedule. In addition, this known method does not provide an easy way to change emphasis on complying with real-time dispatching (RTD) priority versus avoiding scanners idling. In view of this, there is a need for a reticle scheduling method that takes into consideration of both level priority and scanner utilization for all scanners as a whole.

Patent application publication US 2004/0093251 to Heskin et al. and Patent application publication US 2006/0052889 to Burda et al. relate to reticle dispatching. US2004/0093251 to Heskin et al. discloses a system and method for scheduling photolithography in a wafer fab. The approach of reticle scheduling in this prior art involves heuristic based scheduling. US2006/0052889 to Burda et al. relates to a method for modeling manufacturing system through intelligent automated reticle management. In this prior art, reticles are scheduled based on two prioritized list of reticles, reticle load list and reticle remove list.

Furthermore there are patents in the field of dispatching of reticles for photolithographic scanners:

U.S. Patent (U.S. Pat. No. 6,594,817 to Federico et al.) proposes a method for employing a plurality of reusable reticles in an integrated circuit manufacturing process employing lithographic exposure of a semiconductor wafer. Initially there is provided a matrix of a plurality of reticles, each matrix comprising a plurality of tuples of reticles, each reticle tuple comprising one or more reticles. The method then includes defining at least one set of valid groups of reticles in the matrix for use in a desired lithographic exposure process, defining a set of conditions for determining availability of all reticles in the valid groups in the lithographic exposure process, and comparing the availability conditions to the reticles in the set of valid groups and eliminating valid groups which do not meet the availability conditions, leaving non-eliminated valid groups. The method also includes defining a set of conditions for determining priority of all reticles in the non-eliminated valid groups in the lithographic exposure process, comparing the priority conditions to the reticles in the set of valid groups and ranking non-eliminated valid groups according to the priority conditions, and selecting for use in the lithographic exposure process reticles from the non-eliminated valid groups according to ranking by the priority conditions.

U.S. Patent (U.S. Pat. No. 6,403,905 to Conboy et al.) discloses a system and method for stocking and sorting reticles used in a semiconductor fabrication facility, the facility having a material handling system that presents a reticle to a photolithography process area. In an example embodiment of the reticle management system, a reticle storage system and a reticle sorting apparatus are coupled to a host system that is adapted to track and control the movement of reticles in the material handling system. The host system is capable of interfacing with a management input module that integrates management directives into the reticle flow plan in the manufacturing process. The result is a reticle management system that is flexible enough to manage a finite number of reticles and pods in minimizing the delivery time of a reticle to the desired location while responding to changing conditions external to the manufacturing process.

U.S. Patent (U.S. Pat. No. 7,058,627 to Wiesler et al.) discloses a reticle management system that provides data storage and retrieval of data associated with each reticle, reticle carrier, and certain system attributes and also for the efficient movement and storage of reticles and reticle carriers. The reticle management system includes a reticle management controller, a central reticle database, and one or more reticle stockers that include a stocker controller, a stocker database, and a stocker unit. The reticle management controller is coupled to the central reticle database and each of the stocker controllers. Each stocker controller collects data on the reticles, reticle carriers, or both, that are stored within the associated stocker unit and stores this data in the stocker database. The reticle management controller retrieves the data in each stocker database via the associated stocker controller and stores this data in central reticle database. In addition, data attributes for the system, and the reticle carriers within the system may also be stored in the central reticle database.

### SUMMARY OF THE INVENTION

A principal object of the present invention is a method to schedule reticles required for photolithographic processes of a semiconductor manufacturing line.

Another principal object of the present invention is a system to schedule reticles required for photolithographic processes of a semiconductor manufacturing line.

A further object of the present invention is taking into consideration photolithographic level priority and utilization of all photolithographic tools as a whole for reticle scheduling.

Another object of the present invention is providing a user-defined trade-off between photolithographic level priorities and tool utilization as a whole for reticle scheduling.

In accordance with the objects of this invention a method to schedule reticles required for photolithographic processes of a semiconductor manufacturing line, enabling a trade-off between complying with level priority and maximizing utilization of photolithographic tools as a whole has been achieved. The method comprises, first, the initialization steps of (1) providing more than one photolithographic tool, reticles and a computing system to process said scheduling, (2) segmenting planning horizon into time buckets, (3) reading relevant data describing said semiconductor manufacturing line comprising a factor w indicating the trade-off between complying with level priority and maximizing utilization of said photolithographic tools, and (4) determining maximum number m of time buckets required to move reticles between said photolithographic tools. The following steps forming the engine controlling the schedule generation, building a network for optimization and running the optimization comprise (5) determining time buckets to run optimization of reticle dispatching for, (6) building a network for optimization based on inputs from actual line, level priorities and user settings, and (7) running optimization for said optimization network built. The last steps comprise (8) updating semiconductor wafer work-in-process and reticle information based on optimization results and feed results into a reticle delivery system and a wafer lot assignment system, and (9) go back to step (5).

In accordance with the objects of this invention a system to schedule reticles required for photolithographic processes of a semiconductor manufacturing line, enabling a trade-off between complying with level priority and maximizing utilization of photolithographic tools as a whole, has been achieved. The system invented comprises more than one photolithographic tool to process semiconductor wafers, more than one reticle required each for a lithographic level, and a scheduler to schedule said reticles, wherein a user-defined trade off decides between complying with level priority and maximizing scanner utilization for the scanners as a whole.

### BRIEF DESCRIPTION OF THE DRAWINGS

In the accompanying drawings forming a material part of this description, there is shown:

FIG. 1 shows the key components of the system invented.

FIG. 2 illustrates a flowchart with the key steps of the method invented.

FIG. 3 shows a flowchart with detailed steps of controlling the schedule generation over the planning horizon, building a network for optimization, running optimization and performing post-processing.

FIG. 4 illustrates segmenting the planning horizon into time buckets.

FIG. 5 illustrates a sample network for optimization.

FIG. 6 shows the information flow for a single optimization run.

### DESCRIPTION OF THE PREFERRED EMBODIMENTS

The preferred embodiments disclose methods and systems for scheduling of reticles for photolithographic tools of semiconductor manufacturing lines. The methods invented provide a good trade-off between complying with level priority and maximizing utilization of photolithographic tools as a whole. The extent of the trade-off is user-specified depending on excess capacity of photolithographic tools. In a preferred embodiment of the present invention photolithographic scanners are deployed. It has to be noted that the present invention is not limited to scanners only; the invention can be used for other photolithographic tools as e.g. steppers as well.

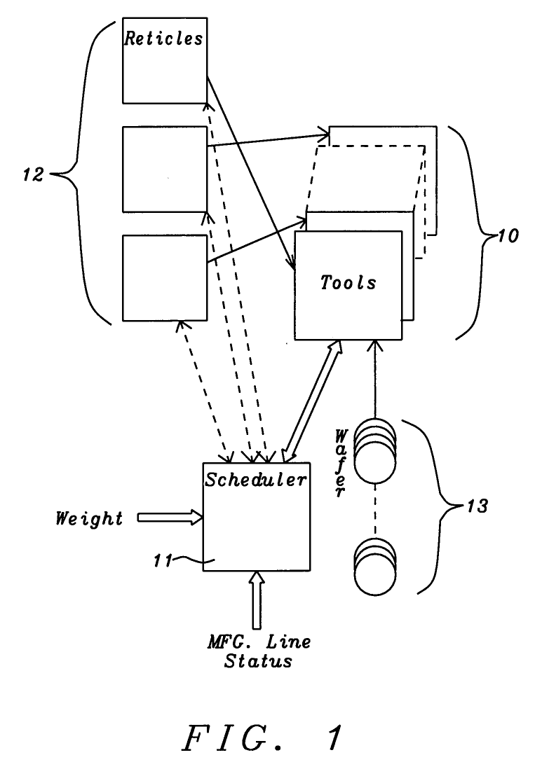

The system of FIG. 1 illustrates the principal components of the system of the present invention. First, there are more than one photolithographic tools 10 of a semiconductor manufacturing line. In a preferred embodiment these tools are photolithographic scanners, they could be of another kind of photolithographic tools as e.g. photolithographic steppers as well. These photolithographic tools 10 require reticles 12 to perform processing of lots of semiconductor wafers 13. These reticles can be physically located either in a scanner, waiting to be run in front of a scanner, in a preventive maintenance station, or waiting in a crib. A reticle scheduler 11 optimizes the reticle schedule providing a good trade-off between complying with level priority and maximizing scanner utilization for the scanner workstation. The manufacturing line status forms a key input to the reticle scheduler 11. In a preferred embodiment this information is provided by a Manufacturing Execution System (MES) and an Equipment Tracking System. Additionally a “weight” factor is provided by a user of the system invented. This “weight” factor represents the user-defined preference in regard of the trade-off between complying with level priority and maximizing scanner utilization for the scanners as a whole. In the following the operation of the reticle scheduler 11 will be explained in detail.

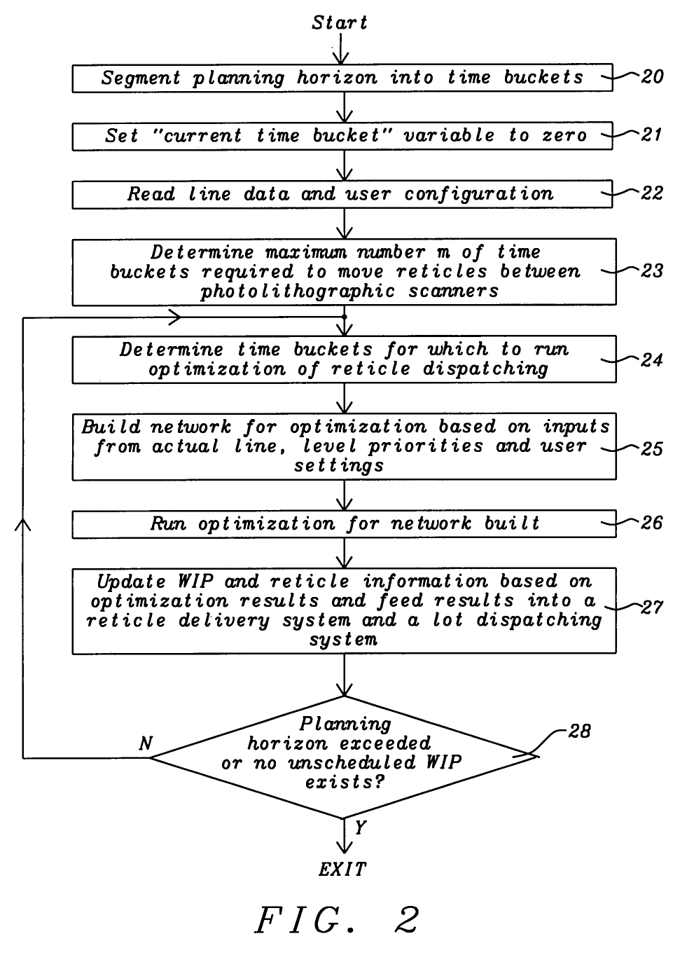

FIG. 2 shows basic steps of the method invented. Steps 20-23 illustrate data initialization steps. This initialization takes place as a first step every time when the reticle scheduler runs. Step 20 shows that during this initialization the planning horizon, which may cover e.g. 6 hours or the duration of a shift, will be segmented into time-buckets to provide a time grid to which the optimization constraints and objectives will be applied. The typical duration of such a time-bucket is the process time for a single lot of semiconductor wafers. This process time may take about 10 minutes. Step 21 introduces the “current time bucket” variable, which is storing the number of time buckets for which the reticle schedule has been determined for all scanners. During initialization the “current time bucket” variable is set to zero.

In order to generate a basis for reticle scheduling important manufacturing line data are read in step 22 from e.g. a manufacturing planning system. In a preferred embodiment of the present invention the following data elements are read in as basis for reticle scheduling. The following list of data elements is a non-limiting example only:
1. Reticle current locations
2. No. of wafer lots to be processed before reticle needs preventive maintenance (PM).
3. Sitting work-in-process (WIP) by device, scanner and photolithographic level
4. Device, photolithographic level priorities
5. Device, photolithographic levels which are temporarily unable to run on a scanner
6. Matrix which shows the mapping between reticles, device, photolithographic level and scanner
7. Alternative scanner on which a lot can be run
8. Number of slots the scanner has to store reticles
9. Scanner state (down/running)
10. Reticle schedule which has been frozen from the last run to avoid system nervousness

In this description a device refers to a product or design identification (ID). Every product has its own set of photolithographic levels.

Additionally to the line data shown above data in regard of user configuration are read in step 22. An important element of the user configuration is the weight w, describing a user-defined trade-off between maximizing scanner utilization and complying with manufacturing line priorities. This weight w has a value from 0 to 1.

When w=1, complete emphasis will be put on complying with level priorities even if it means increased utilization loss for the photolithographic tool due to frequent change of reticles. When w=0, complete emphasis will be put on increasing utilization by minimizing reticle changes, independent of its impact to level priority compliance.

Other elements in the category user configuration include the following:
1. Time to move reticle between scanners and between scanner and stocker.
2. Amount of scanner idling time incurred when reticle is setup on the scanner. This is used in computing the cost of assigning a reticle to a scanner.
3. The variable n, which represents the number of time buckets for which the reticle changes will be optimized in a single optimization run. When n equals 0, only reticle changes occurring at the earliest time bucket t, which needs a reticle change will be optimized. When n>0, reticle changes between t and t+n (both inclusive) will be optimized.
4. The duration of “freezing” the reticle schedule to avoid system nervousness from one optimization run to the next.

Since the time to transfer a reticle from one tool to another can vary depending on the tool location, the maximum transition time is used to consider all reticles that can potentially be moved to the destination tool. This maximum transition time is determined to be m time buckets and is determined in step 23. During these m time buckets the reticle will not be available for use anywhere.

In step 24 the time buckets to optimize the reticle schedule is determined. The following step 25 comprises building a network for optimization based on inputs from actual line (as e.g. WIP, and reticle locations), level priorities, and user configurations (as e.g. the weight w). The next step 26 describes running optimization for the optimization network built during step 25. Step 27 illustrates updating wafer WIP and reticle information based on optimization results and feed results into a reticle delivery system and a lot dispatching system. The delivery system will deliver the reticles to the scanners at the scheduled time. In the case of manual delivery, the operator will be responsible to move the reticles according to the reticle schedule generated. Step 28 is a check if planning horizon is exceeded or no unscheduled WIP exists. If the result of this check is negative the process flow goes back to step 24 to determine time buckets to run the next optimization, otherwise the process flow goes to exit.

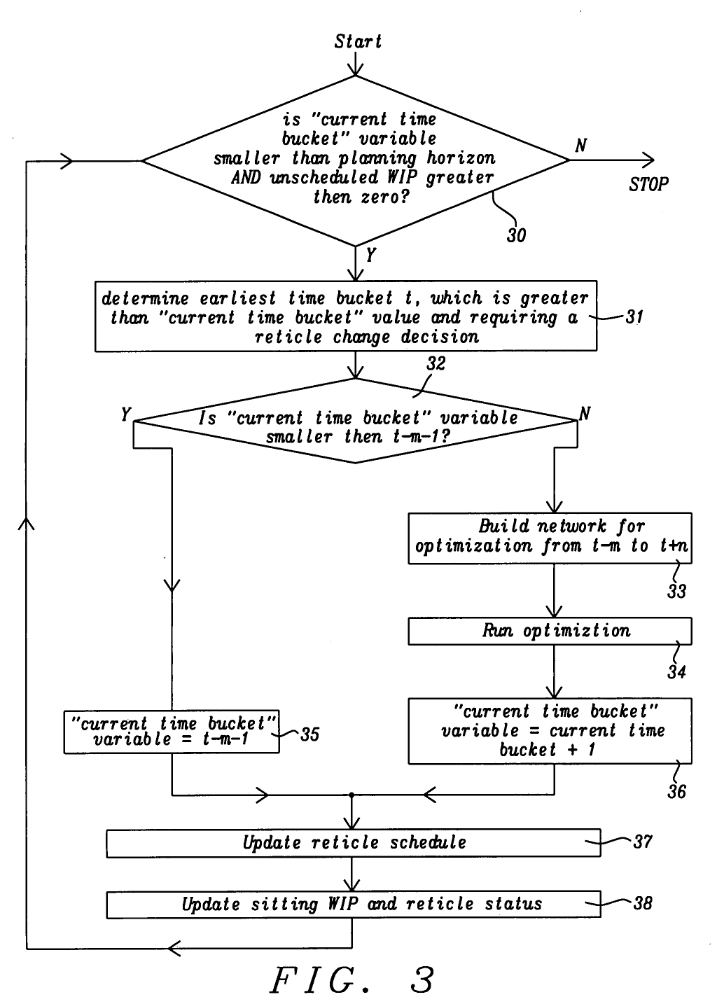

Steps 30-32 of FIG. 3 describe the engine controlling the schedule generation over the planning horizon. These steps 30-32 correspond in more details to step 24 of FIG. 2, which determines the time buckets to optimize the reticle schedule for.

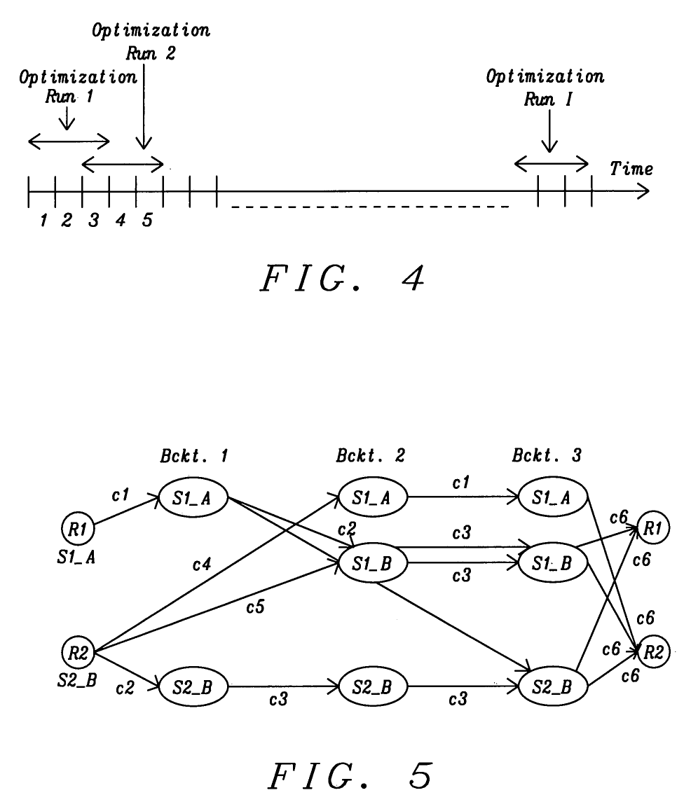

To ensure linearity when running optimization for the network built, separate optimization runs are done to decide which reticle should become active on a scanner based on the result from the previous optimization run. Each optimization run covers m+1+n time buckets. This ensures that all possible reticles, which can be used for reticle changes taking place in the n time buckets, have been considered in the optimization network. Since reticle change decisions might be required for consecutive time buckets, the optimization runs can overlap as shown in FIG. 4.

FIG. 4 serves as a generic diagram to show the segmenting of the time axis into buckets and that optimization runs can overlap. FIG. 4 shows a first optimization run 1 wherein a reticle change decision has to be made at time bucket t=3 and the maximum number of time buckets required to move a reticle is defined m=2. The variable n, which represents the number of time buckets for which the reticle changes will be optimized in a single optimization run, is defined to be 0. When n equals 0, only reticle changes occurring at the earliest time bucket t, which needs a reticle change will be optimized. Therefore a first network for optimization is build from t−m=1 to time bucket t+n=3. In the diagram of FIG. 4 the value of m is consistently 2. In the second optimization run 2, the reticle change decision has to be made at time bucket 5. Therefore a second first network for optimization is build from t−m=3 to time bucket t+n=5.

When the reticle transition time reduces to zero and n equals 0, the optimization runs will not overlap anymore. The engine continues iterating as long as there are unscheduled time buckets in the planning horizon and there is unscheduled sitting WIP available.

Returning to FIG. 3, step 30 of FIG. 3 checks if the current time bucket is smaller than the planning horizon AND if unscheduled work-in process exists and the process flow goes to STOP if this condition is negative, otherwise the process flow continues. In step 31 of FIG. 3 the earliest time bucket t when the reticle needs to be changed is determined based on the last active reticle on each scanner.

This earliest time bucket t is affected by e.g. WIP running out, need to do preventive maintenance (PM) of reticle, scanner going into PM and need to run test wafer for a device level. Step 32 checks the condition if the current reticle configuration needs to be changed, i.e. if the current time bucket variable t is equal or greater than t−m−1. In this case the engine will invoke building a network for optimization in step 33.

Step 33 illustrates the building of a network for optimization. As shown above, this is only performed when the engine invokes it. The network for optimization is built from t−m to t+n. The factor n is user defined and is greater than or equal to 0. When n equals 0, it implies that the optimization is run for reticle changes taking place at current time bucket variable t. If n>0, it implies that optimization is run for reticle changes taking place between t and t+n.

Details about the inputs to building a network for optimization will be described later during the discussion of FIG. 6.

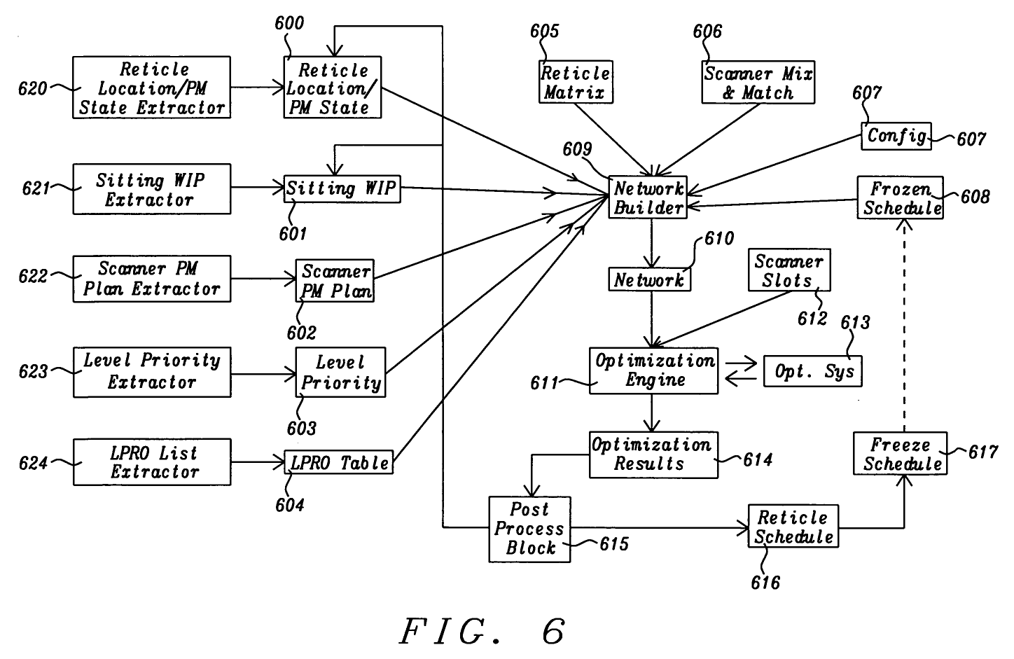

FIG. 5 shows a sample network for optimization over time buckets Bckt.1-Bckt.3. In FIG. 5 two photolithographic scanners S1 and S2 are provided. S1_A represents reticle is running in scanner S1, S1_B represents reticle is waiting in scanner S1, consequently S2_A represents reticle is running in scanner S2, S2_B represents reticle is waiting in scanner S1.

The following cost elements are defined in the sample network of FIG. 5:
c1=cost of processing reticle to continue processing on same scanner
c2=cost of processing reticle to wait in the same scanner
c3=cost of waiting reticle to continue waiting in the same scanner
c4=cost of waiting reticle to process WIP on different scanner
c5=cost of waiting reticle to continue waiting on different scanner
c6=cost for dummy link (typically 0)

Reticle RI is in scanner SI and at time bucket 0 is in production mode whereas reticle R2 is in scanner S2 and is waiting. The WIP for R1 on S1 is assumed to run out by end of time bucket 1 and one time bucket is required to move a reticle from scanner S1 to another (m=1). This information affects the network built. Links created force R1 out of the scanner S1 by end of time bucket 1, because WIP is running out at this point of time. The cost for moving reticles or keeping them in the same scanner, or changing their state from waiting to processing or vice versa are predefined by the user and are indicated by c1 . . . c6. The cost takes into account both the scanner idling time and the impact to line priority. A weight w strikes a trade-off between these two. The weight is defined in the user configurations, which are read in the initialization block in step 22. The cost of a reticle schedule is defined by:

ci=(1−w)×Scanner Idling Time/WIP+w×(Priority),

wherein priority refers to the level priority (element number 4 read from the manufacturing line) and priority=1 indicates highest priority and w represents a user defined weight as described above.

The above cost function will apply to any reticle schedule. The equation for cost element ci covers cost elements c1 . . . c6.

In order to ensure that the scanners are constantly running reticles the cost is offset by a large negative number (e.g. 1000). Thus these active states with low cost are preferred over the inactive states. The equation can be changed to include the offset as follows

ci=(1−w)×Scanner Idling Time/WIP+w×(Priority)−1000,

Returning again to FIG. 3, step 34 illustrates the execution of optimization, i.e. solving the optimization network built in step 33. In step 34 an integer program is created to solve the network built. The objective of the model is to minimize cost given the following constraints
1. Only 1 reticle can be active in a scanner in a time bucket
2. The total number of reticles in a scanner in any time bucket cannot exceed the number of reticle slots available
3. At every network node the flow of material is conserved.

In a preferred embodiment of the invention the network optimization is formulated as an integer program and is solved using the “Branch and Bound” technique. Heuristic solution techniques did not provide as good results as the “Branch and Bound” algorithm which ensures optimality.

Alternatively, the network optimization can be formulated as a Mixed Integer Program and can be solved using algorithms such as “Branch and Cut” and “Branch and Price. Using different formulations and solving techniques will affect the time required for optimization and may affect the quality of the solution.

Steps 35-38 are part of a post-processing block, which updates all the relevant parameters before the next optimization run is executed. If the current time bucket is smaller than t−m−1, the current bucket is adjusted in step 35 to equal t−m−1. This is because the current reticle configuration continues till time bucket t−m−1. If the current time bucket larger than or equal to t−m−1, the reticle locations are updated based on the optimization results from step 34 and the current bucket is incremented by one in step 36.

The reticle schedule is updated in step 37 and the sitting WIP and reticle PM counts are updated in step 38 to reflect the processing of material. Sitting WIP and reticle PM counts are also updated for the next time bucket planning. After step 38 the process flow is going back to step 30.

FIG. 6 shows the information flow of a single optimization run. First the inputs to a network builder 609 building a network of a preferred embodiment as a non-limiting example are illustrated. These inputs directly affect the network structure. The inputs illustrated by FIG. 6 comprises reticle Location/PM State 600, sitting WIP 601 in front of the scanners, PM plan 602 for all scanners, a level priority table 603, an LPRO table 604, a reticle matrix 605, Scanner Mix and Match 606, user defined configuration 607, and a frozen reticle schedule 608. The data elements 605-608 are contained in tables.

The LPRO Table 604 identifies, which device/level cannot be run on a scanner because it is temporarily facing a problem (e.g. needs qualification). For these device/levels no material is scheduled to run on the photolithographic tool.

The Reticle Matrix 605 defines which reticle is used for which device/level and is released on which scanner to run.

The Scanner Mix & Match table 606 identifies alternate scanners on which WIP for a particular device/step can be run

The data elements 600-604 are extracted from the Manufacturing Execution and Equipment Tracking Systems via extractors 620-624 during initialization phase.

It has to be noted that the number of inputs can be increased or decreased. For example different types of preventive maintenance can be factored in for the reticles. Such variations will affect the network creation of step 33 of FIG. 3. The cost factors for making each kind of a reticle movement decision are predefined by the user. The cost factors as shown in FIG. 5 will be used in the Network Builder component 609 of FIG. 6. Data from Configuration, Sitting WIP and Level priority blocks will be used to compute the cost.

Furthermore FIG. 6 shows the key processing steps after the network builder 609 has built an optimization network 610. An Optimization Engine 611 optimizes the network 610 using an optimization system 613 after taking scanner slots 612 into consideration.

The number of scanner slots determines the number of reticles that can be physically kept in the scanner at any point of time and is setup by the user based on the photolithography tool. This serves as a constraint in the optimization.

Details about optimization have been discussed earlier in regard of the discussion of step 34 of FIG. 3. The optimization results are stored in a table 614 and serve as input to post-processing program 615. The post-processing program 615 builds a table comprising an optimized reticle schedule table 616 and updates Reticle Location/PM State 600 and Sitting WIP information 601 as already shown in steps 37 and 38 of FIG. 3. The reticle schedule table 616 is input to a “Freeze schedule” program, which generates a “frozen schedule” table 608. The beginning portion of the reticle schedule is frozen to avoid system nervousness.

There are two key advantages of the system. First, that it is not biased to an individual scanner when allocating a reticle to it. Such bias can adversely affect the quality of the reticle schedule for the remaining scanners. This is important because the optimum needs to be ensured for the scanner workstation as a whole instead of individual tools.

The second key advantage is that scanner utilization loss depends on the emphasis given to complying with line priority versus avoiding scanner idling. These can be conflicting objectives. The traditional heuristic based approaches do not allow easy control on the objective of the system. Depending on the excess capacity available at the scanner the present invention emphasizes complying with line priority versus maximizing scanner utilization.

Furthermore it has to be noted that the present invention can be distinguished from the prior art known because the present invention discloses system and methods comprising building a network model that takes into account starting location of reticles, time to set-up reticle and cost of assigning reticle for optimization of reticle schedule on all scanners.

While the invention has been particularly shown and described with reference to the preferred embodiments thereof, it will be understood by those skilled in the art that various changes in form and details may be made without departing from the spirit and scope of the invention.

What is claimed is:

1. A method to schedule reticles required for photolithographic processes of a semiconductor manufacturing line, enabling a trade-off between complying with level priority and maximizing utilization of photolithographic tools as a whole, comprising the steps of
(1) providing more than one photolithographic tool, reticles and a computing system to process said scheduling;
(2) segmenting planning horizon into time buckets;
(3) reading relevant data describing said semiconductor manufacturing line and user configuration comprising a factor w indicating the trade-off between complying with level priority and maximizing utilization of said photolithographic tools;
(4) determining maximum number m of time buckets required to move reticles between said photolithographic tools;
(5) determining time buckets for which optimization of reticle dispatching is required;
(6) building a network for optimization based on inputs from actual line, level priorities and user settings;
(7) running optimization for said optimization network built;
(8) updating semiconductor wafer work-in-process and reticle information based on optimization results and feed results into a reticle delivery system and a wafer lot assignment system; and
(9) go back to step (5) until planning horizon is exceeded or there is no unscheduled work-in-process.

2. The method of claim 1 wherein said time-buckets have a duration according process time of a single lot of semiconductor wafers.

3. The method of claim 1 wherein said photolithographic tools are photolithographic scanners.

4. The method of claim 1 wherein said photolithographic tools are photolithographic steppers.

5. The method of claim 1 wherein said relevant data describing said manufacturing line comprise:
reticle current locations;
number of wafer lots to be processed before reticle needs preventive maintenance (PM);
sitting work-in-process (WIP) by device, photolithographic tool and photolithographic level;
device, photolithographic level priorities;
device, photolithographic levels that are temporarily unable to run on photolithographic tool;
matrix, which shows the mapping between reticles, device, photolithographic level and photolithographic tool;
alternative photolithographic tool on which a lot can be run;
number of slots the photolithographic tool has to store reticles;
photolithographic tool state; and
reticle schedule, which has been frozen from the last run to avoid system nervousness.

6. The method of claim 1 wherein said user configuration comprises:
time required to move reticle between photolithographic tools and photolithographic tools and stocker;
amount of photolithographic tool idling time incurred when reticle is setup on a photolithographic tool;
a variable n, which represents a number of time buckets for which reticle changes will be optimized in a single optimization run;
a duration of freezing a reticle schedule to avoid system nervousness from one optimization run to the next.

7. The method of claim 1 wherein said factor w has a value between 0 and 1 wherein a level of 1 signifies a complete emphasis on level priority and a level of zero signifies a complete emphasis on tool utilization.

8. The method of claim 1 wherein each optimization run covers m+1+n time buckets, wherein m corresponds to said maximum number of time buckets required to move a reticle between said photolithographic tools and said variable n is the number of time buckets for which the reticle changes will be optimized.

9. The method of claim 1 wherein said optimization is performed as long as there are unscheduled time buckets and there is unscheduled wafer work-in-process sitting in front of one of said photolithographic tools.

10. The method of claim 1 wherein said optimization is initiated if a current reticle configuration needs to be changed.

11. The method of claim 10 wherein said current reticle configuration has to be changed because wafer work-in-process is running out.

12. The method of claim 10 wherein said current reticle configuration has to be changed because preventive maintenance of a reticle has to be performed.

13. The method of claim 10 wherein said current reticle configuration has to be changed because one of said photolithographic tools has to undergo a preventive maintenance.

14. The method of claim 1 wherein said inputs from actual line, level priorities and user settings comprise:
locations of reticles;
reticles preventive maintenance states;
work-in-process states;
preventive maintenance plan for said photolithographic tools;
priorities for photolithographic levels;
a table identifying which device/level cannot be run on a photolithographic tool;
a reticle matrix defining which reticle is used for which device/level;
a tool mix and match table identifying alternate photolithographic tools on which WIP for a particular device/step can be processed;
configuration of photolithographic tools; and
said factor w.

15. The method of claim 14 wherein additional data elements are used to build the network.

16. The method of claim 14 wherein less data elements are used to build the network.

17. The method of claim 1 wherein cost elements, predefined by a user and added to said network, comprising:
cost of processing reticle to continue processing on same photolithographic tool;
cost of processing reticle to wait in the same photolithographic tool;
cost of waiting reticle to continue waiting in the same photolithographic tool;
cost of waiting reticle to process WIP on different photolithographic tool; and
cost of waiting reticle to continue waiting on different photolithographic tool.

18. The method of claim 1 wherein the costs of a reticle schedules is defined by the equation:
ci=(1−w)×Photolithographic Tool Idling Time/WIP+w×(Priority),
wherein w is said factor w indicating the trade-off and priority=1 indicates highest priority.

19. The method of claim 1 wherein the costs of a reticle schedules is defined by the equation:
ci=(1−w)×Photolithographic Tool Idling Time/WIP+w>(Priority)−offset,
wherein w is said factor w indicating the trade-off and priority=1 indicates highest priority and offset is a number used to prefer active states with low cost to inactive states.

20. The method of claim 1 wherein an Integer Program is used to formulate the network optimization.

21. The method of claim 20 wherein a Branch and Bound algorithm is used to solve the Integer Program.

22. The method of claim 1 wherein Branch and Cut and Branch and Price algorithms are used to solve the network optimization formulation.

23. The method of claim 1 wherein a Mixed Integer Program is used to formulate the network optimization.

24. The method of claim 1 wherein constraints of said optimization run comprise:
only one reticle can be active in a photolithographic tool in a time bucket;
the total number of reticles in a photolithographic tool in any time bucket cannot exceed the number of reticle slots available, and
at every network node the flow of material is conserved.

25. The method of claim 1 wherein said determination of time buckets for which optimization of reticle schedule is required and said optimization comprising steps of:
(1) checking if a current time bucket is smaller than a planning horizon AND if unscheduled WIP is greater than zero and discontinuing process flow if this check is negative otherwise proceeding with step 2;
(2) determining earliest time bucket t, which is greater than said current time bucket and requiring a reticle change decision;
(3) checking if current time bucket is smaller than a value v=t−m−1, wherein m is said maximum number of time buckets required to move reticles and t is said earliest time bucket, and proceed with step 7 if this check is positive, otherwise proceed with step 4;
(4) building network for optimization from time bucket t−m to t+n, wherein n is a user defined factor representing additional number of time buckets during which the optimization is performed;
(5) running optimization using said optimization network;
(6) increasing the number of said current time bucket by 1 and go to step 8;
(7) setting said current time bucket to said value v=t−m−1;
(8) updating reticle schedule; and
(9) updating WIP and reticle status and go to step 1.

26. The method of claim 25 wherein determination of said earliest time bucket t is performed considering WIP running out, need to do preventive maintenance of a reticle, photolithographic tool going into PM and need to run test wafer for a device level.

27. A system to schedule reticles required for photolithographic processes of a semiconductor manufacturing line, enabling a trade-off between complying with level priority and maximizing utilization of photolithographic tools as a whole, comprising:
more than one photolithographic tool to process semiconductor wafers;
more than one reticle required each for a lithographic level; and
a scheduler to schedule said reticles, wherein a user-defined trade off decides between high-level priorities and scanner utilization for the scanners as a whole.

28. The system of claim 27 wherein said photolithographic tool is a photolithographic scanner.

29. The system of claim 27 wherein said photolithographic tool is a photolithographic stepper.

30. The system of claim 27 wherein said scheduler optimizes a network that takes into account starting locations of said reticles, time to set-up the reticles and cost of assigning reticles for optimization of reticle schedules on all scanners.
